(19) United States
(12) Patent Application Publication
(10) Pub. No.: US 2015/0019331 A1
(43) Pub. Date: Jan. 15, 2015

(54) ADVERTISEMENT AUCTION SYSTEM

(71) Applicant: Criteo SA, Paris (FR)

(72) Inventors: Loic Chambard, Paris (FR); Nicolas Messelet, Bordeaux (FR); Frederic Clement, Paris (FR)

(21) Appl. No.: 13/942,408

(22) Filed: Jul. 15, 2013

(51) Int. Cl. G06Q 30/02

(52) U.S. Cl. CPC G06Q 30/0255
USPC 705/14.53

(57) ABSTRACT

Described are methods, systems, and apparatus, including computer program products for auctioning webpage display ads. A first request is received from a requester loading a first webpage for indicia of one or more impression opportunities. A second request is sent to a plurality of third parties for one or more bids for a first impression opportunity. Whether to select the first impression opportunity is determined based on the one or more bids received from one or more of the plurality of third parties. If the first impression opportunity is selected: first ad information is stored; the indicia of one or more impression opportunities are generated; the indicia are sent to the requester; a third request is received from the requestor for an ad to populate the first impression opportunity on a second webpage, the request including indicia of one or more ad buyers; and a first ad is sent.

### FIELD OF THE INVENTION

The present technology relates generally to webpage display ads and, more specifically, to an auction system for webpage display ads.

### BACKGROUND

Online and other electronic advertising allows advertisers to display advertisements (or ads) to end users, including those who are potential customers. For example, a webpage can include one or more opportunities for inserting advertisements (e.g., space for a banner advertisement across the top of the webpage, spaces for advertisements along the sides of the webpage, overlays, etc.). When a user device (e.g., a computer running a web browser) processes a webpage for display, the user device can request an advertisement for one of the advertising opportunities on the webpage from an advertising server (or ad server). The ad server can select an advertisement for display within the area of the webpage associated with the advertising opportunity. For example, the ad server can select, based on declarative rules set by the publisher, a banner ad from a particular advertiser from a set of multiple banner ads from multiple advertisers for display to the user in the banner ad space of the webpage. Each presentation of an advertisement within a webpage can he referred to as an impression.

Ad networks have developed to enable advertisers to find available advertising opportunities (e.g., spaces on webpages in which to display their ads) and to provide publishers a way to find ads to be displayed on their webpages. For example, a publisher can use a realtime bidding platform to sell an impression to an advertiser (e.g., the winning bidder advertiser can provide the advertisement that will be displayed to a user). When the user device processes a webpage for display, the web browser can request an advertisement for one of the impression opportunities on the webpage. In response to this request, the realtime bidding platform can request bids from advertisers for the impression opportunity. The realtime bidding platform can collect bids from competing advertisers and select the advertiser having the highest bid. The publisher, or one of its ad servers, can then provide to the user an ad from the advertiser having the highest bid. In order to limit the delay experienced by the user device waiting for the ads to display, such realtime bidding platforms can often require advertisers to submit bids within, e.g., 100 milliseconds. Accordingly, realtime bidding platforms can be less tolerant of bidders that do not respond in the limited time window.

### SUMMARY OF THE TECHNOLOGY

The technology described herein facilitates a publisher to offer impression opportunities to an advertiser, on an impression-by-impression basis. In some embodiments, the technology can permit relaxing the bidding timing requirements of existing realtime bidding platforms.

In one aspect, there is a method performed by a computing system. The method can include receiving, by the computing system, a first request from a requester loading a first webpage for indicia of one or more impression opportunities. The method can include sending, by the computing system, a second request to a plurality of third parties for one or more bids far a first impression opportunity. The method can include determining, by the computing system, whether to select the first impression opportunity based on the one or more bids received from one or more of the plurality of third parties. If the first impression opportunity is selected, the method can include; storing, by the computing system, first ad information related to the first impression opportunity; generating, by the computing system, the indicia of one or more impression opportunities comprising indicia of the first impression opportunity; sending, by the computing system, the indicia of one or more impression opportunities to the requester; receiving, by the computing system, a third request from the requestor for an ad to populate the first impression opportunity on a second webpage, the request comprising indicia of one or more ad buyers; and sending, by the computing system, a first ad based on the first ad information and the indicia of one or more ad buyers to the requester.

In some embodiments, the method can include receiving, by the computing system, one or more keywords from the requester, where the request (e.g. the first request or the third request) comprises the one or more keywords. In some embodiments, the method can include determining, by the computing system, a largest bid of the one or more bids; and selecting, by the computing system, the first impression opportunity if the largest bid is greater than or equal to a cost associated with the first impression opportunity. In some embodiments, the method can include determining, by the computing system, a value of the first impression opportunity. In some embodiments, the method can include determining, by the computing system, a largest bid of the one or more bids. In sonic embodiments, the method can include selecting, by the computing system, the first impression opportunity if the value or the largest bid is greater than or equal to a cost associated with the first impression opportunity.

In some embodiments, the method can include sending, by the computing system, storage instructions to the requester to store the indicia of the one or more impression opportunities. In some embodiments, the storage instructions comprise instructions to store the indicia of the one or more impression opportunities for a duration of time. In some embodiments, the storage instructions comprise instructions to store the indicia of the one or more impression opportunities as a web browser cookie. In some embodiments, the indicia of the one or more impression opportunities comprise one or more keywords associated with an ad server.

In another aspect, there is a method performed by a computing system. The method can include sending, by the computing system, to an of decision system a first request for indicia of one or more impression opportunities in response to loading a first webpage. The method can include storing, by the computing system, the indicia of one or more impression opportunities received from the ad decision system. The method can include storing, by the computing system, indicia of one or more ad buyers, wherein each ad buyer of the one or more ad buyers is associated with at least one impression opportunity of the one or more impression opportunities. The method can include sending, by the computing system, a second request comprising the indicia of one or more impression opportunities to an ad server for an ad to populate the first impression opportunity on a second webpage. The method can include receiving, by the computing system, first ad instructions from the ad server. The method can include sending, by the computing system, a third request comprising the indicia of one or more ad buyers to the ad decision system.

In some embodiments, the method includes sending, by the computing system, to the ad decision system one or more key-values associated with the one or more impression opportunities. In some embodiments, the method includes receiving, by the computing system, storage instructions from the ad decision system to store the indicia of the one or more impression opportunities on the computing system. In some embodiments, the storage instructions comprise instructions to store the indicia of the one or more impression opportunities for a duration of time on the computing system. In some embodiments, the storage instructions comprise instructions to store the indicia of the one or more impression opportunities as a web browser cookie on the computing system. In some embodiments, the indicia of the one or more impression opportunities comprise one or more keywords associated with an ad server.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a diagram of a system in accordance with an embodiment of the technology;

FIGS. 2A and 2B depict a flow chart illustrating a method of providing ads to a user device in accordance with an embodiment of the technology;

FIGS. 3A and 3B depict a flow chart illustrating a method of providing ads to a user device utilizing an auction platform in accordance with an embodiment of the technology;

FIG. 4 depicts a flow chart illustrating a method performed by an ad decision system in accordance with an embodiment of the technology; and

FIG. 5 depicts a flow chart illustrating a method performed by a user device in accordance with an embodiment of the technology.

### DETAILED DESCRIPTION

The present technology relates generally to website display ads. The technology can facilitate selecting advertisements for and delivering advertisements to user devices, such as a part of a webpage, an application (e.g., a mobile application), etc. The technology can facilitate advertisers in identifying the impression opportunities that they wish to purchase. In some embodiments, the technology can permit advertisers or their agents to decide at the time a user is displaying a webpage whether to purchase impressions on a subsequent webpage.

In an exemplary implementation of the technology, a user device (e.g., a computer running web browser software) can request a webpage from a publisher webserver. The publisher webserver can provide a webpage with one or more spaces for advertisements (e.g., one or more impression opportunities) in response to the user device's request. The webpage can include instructions for performing various actions. When the user device processes the webpage for display, the user device can request from an ad decision system indicia of impression opportunities for which the ad decision system determines it can provide ads. For example, the ad decision system can determine to provide an ad for an impression opportunity when it determines that impression opportunity is likely profitable (e.g., the expected value of the impression opportunity exceeds the cost of the impression opportunity). The ad decision system can request bids for the impression opportunity from third parties and determine to provide an ad when a third party indicates it is willing to pay an amount equal to or greater than the cost of the impression opportunity.

The ad decision system can provide indicia of the one or more impression opportunities that are desired (e.g., indicia of the one or more impression opportunities for which the ad decision system determines it can provide ads) and/or information about which advertisers had the winning bids for the impression opportunities. The user device can store the indicia of the one or more impression opportunities and/or information about which advertisers had the winning bids for the impression opportunities, so that the indicia (and/or information about advertisers) can be delivered to the publisher ad server and/or the ad decision system when the user device processes a subsequent publisher webpage. Concurrently with the previous auction process, the user device can complete displaying the webpage.

Subsequently (e.g., 3 minutes later), the user device can request a second webpage from the publisher webserver. When requesting ads for insertion into the impression opportunities on the second page, the user device can pass the indicia of the one or more impression opportunities to the publisher ad server, which informs the publisher ad server that the ad decision system is willing to provide ads for those impression opportunities. The publisher ad server can select ads for the impression opportunities (e.g., either ads that will be provided by the ad decision system or ads associated with another advertiser) and deliver the ads (or ad tags directing the user device to where the ad can be retrieved) to the user device for display in the webpage. If the publisher ad server selects the ad decision system to provide an ad for an impression opportunity (e.g., based on the ad server targeting on the provided indicia of the one or more impression opportunities), the ad server can provide an ad tag that will direct the user device to request an ad from the ad decision system. The user device can request an ad from the ad decision system, passing stored information, about which advertisers had the winning bids for the impression opportunities. If a third party bidder will provide the ad (e.g., the third party bidder submitted the highest bid), the ad decision system can provide an ad tag directing the user device to the third party's server (or deliver the ad on behalf of the third party).

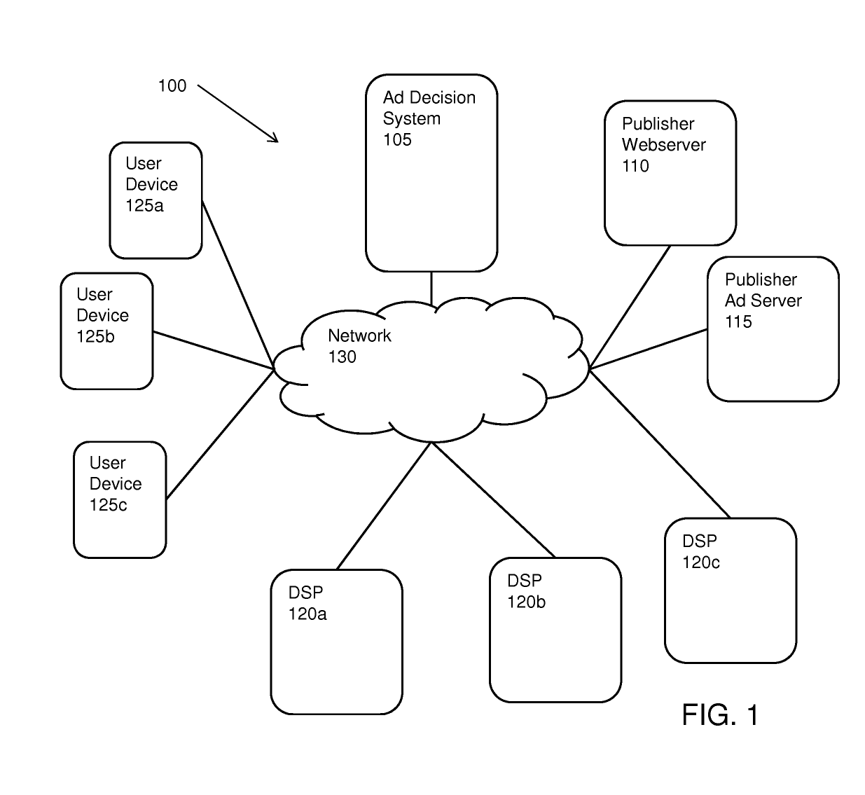

FIG. 1 is a diagram of system 100 in accordance with an embodiment of the technology. As illustrated, system 100 can include an ad decision system 105, publisher webserver 110, publisher ad server 115, demand side platforms (DSPs) 120, and user devices 125. In system 100, ad decision system 105, publisher webserver 110, publisher ad server 115, DSPs 120, and user devices 125 can be in data communication with each other via network 130.

Ad decision system 105 can be any computing system comprising one or more computing devices, such as servers. In some embodiments, ad decision system 105 can evaluate impression opportunities to determine the desirability of the impression opportunities. For example, ad decision system 105 can determine whether it is desirable to purchase an impression opportunity based on data related to the impression opportunity. In some embodiments, ad decision system 105 can determine it is desirable to purchase an impression opportunity when the price an advertiser is willing to pay for the impression opportunity exceeds the price of the impression opportunity. In sonic embodiments, ad decision system 105 can determine it is desirable to purchase an impression opportunity when the expected value of the impression opportunity (e.g., based on estimated likelihood of the user clicking on the ad) exceeds the cost of the impression opportunity. The data related to the impression opportunity can include historical, demographic, or behavioral information about the end user to which the ad will be displayed, information about the webpage on which the ad will be displayed, information about the advertiser, or any other relevant information.

Publisher webserver 110 can be any computing system comprising one or more computing devices, such as servers. In some embodiments, publisher webserver 110 can serve webpages (e.g., to user devices 125). Publisher ad server 115 can be any computing system comprising one or more computing devices, such as servers. In sonic embodiments, ad server 115 can serve ads or ad tags (e.g., HTML ad tags, such as JavaScript code or an Iframe) (e.g., to user device 125). DSP 120 can be any computing system comprising one or more computing devices, such as servers. In some embodiments, DSP 120 can provide bids on an impression opportunity. User device 125 can be any computing system comprising one or more computing devices, such as servers, personal computers, tablets, or mobile devices. In some embodiments, user device 125 can request webpages.

### Ad Selection and Delivery

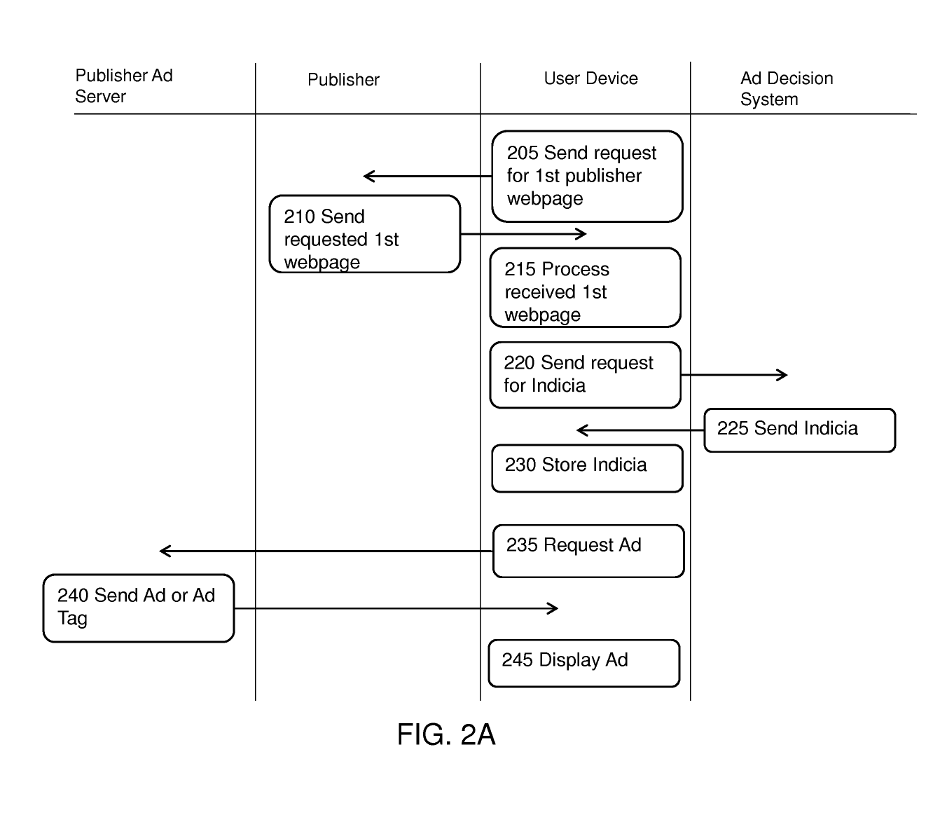

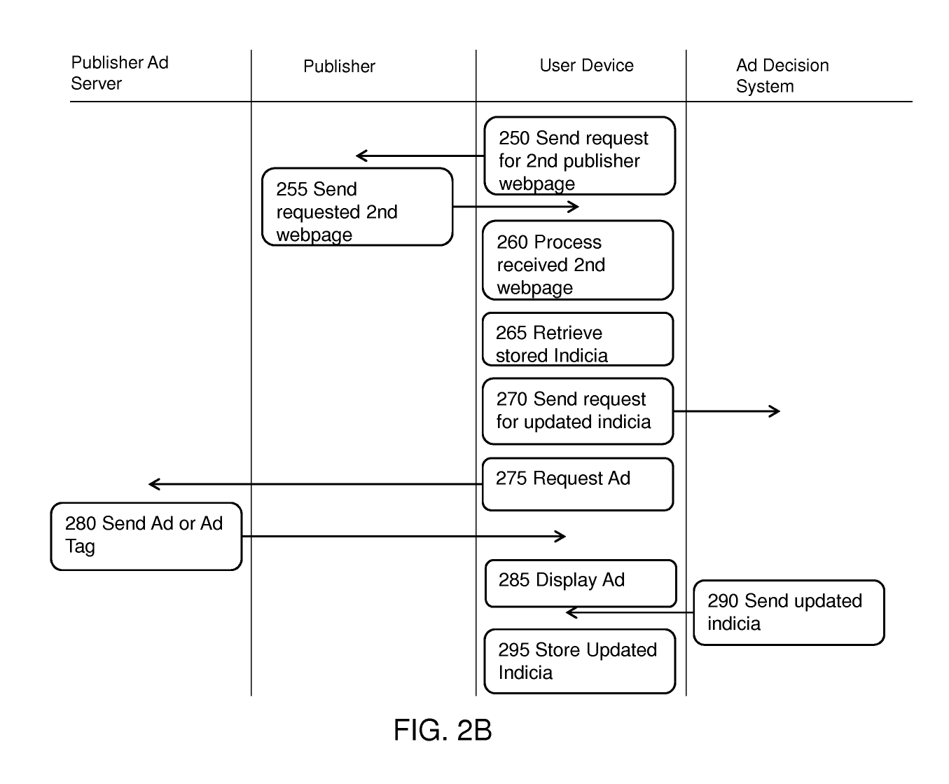

FIGS. 2A and 2B depict a flow chart illustrating a method of providing ads to a user device in accordance with an embodiment of the technology. At step 205, a user device (e.g., user device 125) sends a request for a first webpage to a publisher webserver (e.g., webserver 110). In some embodiments, the request can be in accordance with the HTTP protocol (e.g., an HTTP GET method). At step 210, the publisher webserver sends the requested first webpage to the user device. In some embodiments, the response can be in accordance with the HTTP protocol. At step 215, the user device processes the first webpage. For example, the user device can process the first webpage HTML code in order to render the first webpage on a display of the user device and to execute instructions (e.g., javascript and/or HTML tags) included in and/or referenced by the first webpage source code. At step 220, the user device, sends a request to an ad decision system (e.g., ad decisions system 105) for indicia of one or more impression opportunities. In some embodiments, the first webpage can include instructions (e.g., javascript and/or HTML tags) that, when executed by the user device, can cause the user device to send a request for the indicia of one or more impression opportunities to an ad decision system. For example, the first webpage can include a script (e.g., javascript) that causes the use device to request from the ad decision system the indicia of one or more impression opportunities.

At step 225, the ad decision system responds with indicia of one or more impression opportunities. In some embodiments, the ad decision system can respond to the user device with a character string including the indicia of one or more impression opportunities. In some embodiments, the ad decision system can respond with instructions (e.g., javascript and/or HTML tags) that, when executed by the user device, can cause the user device to set the value of a variable (e.g., a javascript variable) as the indicia of one or more impression opportunities.

As noted above, the indicia of one or more impression opportunities can identify impression opportunities (e.g., a top banner on a webpage, etc.). In some applications, a publisher ad server (e.g., the publisher ad server 115) can be configured such that certain keywords are recognized as an indication that the ad decision system can provide ads for the impression opportunities associated with the keywords. The indicia can include one or more keywords associated with impression opportunities. For example, the keyword “imp728” can correspond to a 728×90 pixel impression opportunity across the top of a webpage (e.g., the banner); the keyword “imp300” can correspond to a 300×250 pixel impression opportunity along the side of a webpage; and the keyword “imp160” can correspond to a 160×600 pixel impression opportunity. An exemplary response by the ad decision system can include “imp728;imp300;” as indicia of the 728×90 pixel impression opportunity and the 300×250 pixel impression opportunity.

In some embodiments, the ad decision system can selectively determine for which impression opportunities it will send indicia (e.g., to indicate the impression opportunities for which it can provide ads). In some embodiments, the ad decision system can determine whether it is desirable to purchase an impression opportunity when the expected value of the impression opportunity (e.g., based on estimated likelihood of the user clicking on the ad) exceeds the cost of the impression opportunity. For example, the ad decision system can determine that it is desirable to purchase the 300×250 pixel impression opportunity and the 160×600 pixel impression opportunity. The ad decision system can send indicia of the 300×250 pixel impression opportunity and the 160×600 pixel impression opportunity (e.g., keywords “imp300;imp160;”) to the user device.

At step 230, the user device stores the indicia of one or more impression opportunities received from the ad decision system. In some embodiments, the indicia can be stored as a cookie set on the domain of the first webpage. For example, the first webpage can include instructions (e.g., javascript) to store as a cookie the value of a variable containing the indicia of one or more impression opportunities. It should be appreciated that the illustrated example depicts one of many possible sequences of steps. In some instances, the user device can process the first webpage (e.g., as described below with respect to steps 235 through 245) before the ad decision system sends the indicia of one or more impression opportunities (e.g., as described with respect to step 225). As will be described in greater detail below, the user device can utilize stored indicia of one or more impression opportunities.

At step 235, the user device sends a request to a publisher ad server (e.g., publisher ad server 115) for an ad for displaying in an impression opportunity on the first webpage. In some embodiments, the request includes the indicia of one or more impression opportunities. For example, the indicia can be appended as parameters to the URL of the request to the publisher ad server, so that the indicia are passed to the publisher ad server.

At step 240, the publisher ad server responds with an ad or ad tag. In some embodiments, the publisher ad server determines which ad or ad tag to send based in part on the indicia of one or more impression opportunities included in the request that it received from the user device (e.g., the publisher ad server can use a keyword targeting feature). In some embodiments, the publisher ad server can send a URL of the selected ad. In some embodiments, the publisher ad server can send an ad tag that, when processed by the user device, directs the user device to the location from which to retrieve the selected ad.

At step 245, the user device displays the ad in the location of the impression opportunity on the webpage. In some embodiments, the user device can obtain the ad for the impression opportunity from a URL provided by the publisher ad server. In some embodiments, the user device can obtain the ad for the impression opportunity by processing an ad tag provided by the publisher ad server (or by processing a series of ad tags).

At step 250, the user device sends as request for as second webpage to the publisher webserver. For example, the user device can request an updated version of the first webpage requested in step 205 or the user device can request another webpage hosted by the publisher. In some embodiments, the request can be in accordance with the HTTP protocol (e.g., an HTTP GET method). At step 255, the publisher webserver sends the second webpage to the requesting user device. In some embodiments, the response can be in accordance with the HTTP protocol. At step 260, the user device processes the second webpage. For example, the web browser can process the second webpage source code in order to render the second webpage on a display of the user device and to execute instructions (e.g., javascript and/or HTML tags) included in and/or referenced by the second webpage source code.

At step 265, the user device retrieves stored indicia of one or more impression opportunities. As described above, the user device can store the indicia of one or more impression opportunities received from the ad decision system during the display of a previous webpage (e.g., the first webpage displayed in step 230). In some embodiments, the second webpage can include instructions (e.g., javascript and/or HTML tags) that, when executed by the user device, can cause the user device to retrieve the stored indicia of one or more impression opportunities. For example, the user device can retrieve the indicia of one or more impression opportunities stored in a cookie set on the domain of the first webpage requested in step 230 (e.g., when the second webpage is on the same domain as the first webpage). The second webpage can include instructions (e.g., javascript) to retrieve from a cookie the indicia of one or more impression opportunities and set the value of a variable to the indicia of one or more impression opportunities.

At step 270, the user device sends a request to the ad decision system for updated indicia of one or more impression opportunities. In some embodiments, the second webpage can include instructions (e.g., javascript and/or HTML tags) that, when executed by the user device, can cause the user device to send a request for the updated indicia of one or more impression opportunities to the ad decision system. For example, the second webpage can include a script (e.g., javascript) that causes the user device to request from the ad decision system the updated indicia of one or more impression opportunities. In some embodiments, the user device can provide the indicia retrieved in step 265 along with the request.

At step 275, the user device sends a request to the publisher ad server for an ad for displaying in an impression opportunity on the second webpage. In some embodiments, the request includes the indicia of one or more impression opportunities. For example, the indicia can be appended as parameters to the URL specified for the publisher ad server. In the illustrated embodiment, the user device has not yet received a response to its request for updated indicia of one or more impression opportunities (e.g., step 270). The user device can provide the indicia of one or more impression opportunities retrieved in step 265.

At step 280, the publisher ad server responds with an ad or ad tag. In some embodiments, the publisher ad server determines which ad or ad tag to send based in part on the indicia of one or more impression opportunities included in the request that it received from the user device (e.g. the publisher ad server can use a keyword targeting feature). In some embodiments, the publisher ad server can send a URL of the selected ad. In some embodiments, the publisher ad server can send an ad tag that, when processed by the user device, directs the user device to the location from which to retrieve the selected ad.

At step 285, the user device displays the ad in the location of the impression opportunity on the second webpage. In some embodiments, the user device can Obtain the ad for the impression opportunity from a URL provided by the publisher ad server. In some embodiments, the user device can obtain the ad for the impression opportunity by processing an ad tag provided by the publisher ad server.

At step 290, the ad decision system responds with updated indicia of one or more impression opportunities. The ad decision system can respond in any of the ways described above.

At step 295, the user device stores the updated indicia of one or more impression opportunities received from the ad decision system. In some embodiments, the updated indicia can be stored as a cookie set on the domain of the requested second webpage. For example, the received second webpage can include instructions (e.g., javascript) to store as a cookie the value of a variable containing the updated indicia of one or more impression opportunities.

The illustrated example depicts a possible sequence of steps. It should be appreciated that steps can occur in different order. For example, the user device can process the webpage and request indicia of one or more impression opportunities from the ad decision system in parallel. The user device can request an ad (e.g., as in step 235) before the ad decision system sends indicia of one or more impression opportunities (e,g., as in step 225). In some embodiments, the user device can provide an empty string to the ad server (e.g., when the ad decision system has not provided indicia of one or more impression opportunities yet or when the ad decision system determines that none of the impression opportunities are desired). In some embodiments, the use device can provide indicia of one or more impression opportunities received while processing a previous webpage (e.g., as described with respect, to steps 250 through 295).

### Auction Platform

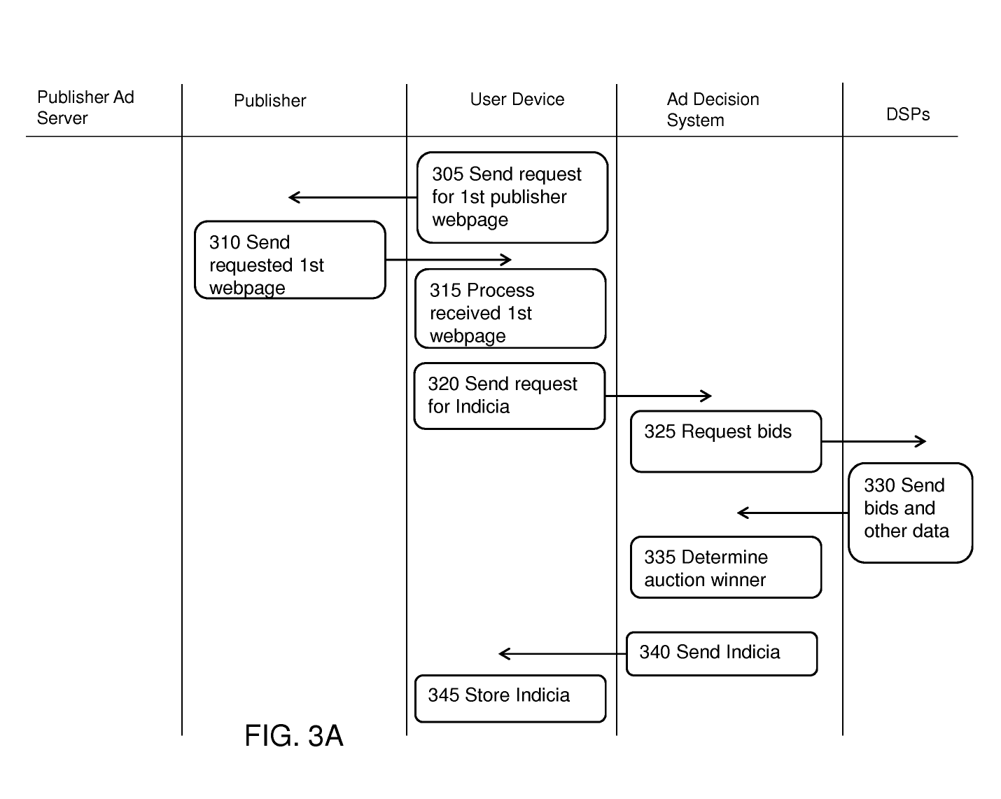

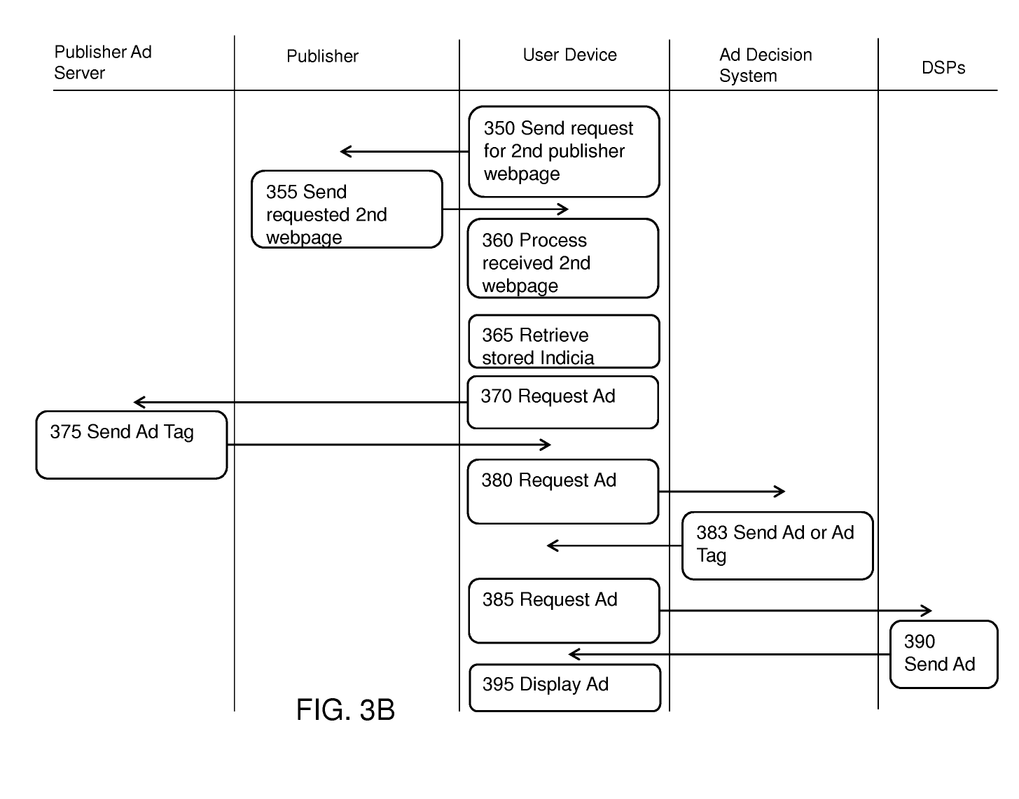

FIGS. 3A and 38 depict a flow chart illustrating a method of providing ads to a user device by utilizing an auction platform in accordance with an embodiment of the technology. At step 305, a user device (e.g., user device 125) sends a request for a first webpage to a publisher webserver (e.g., webserver 110). In some embodiments, the request can he in accordance with the HTTP protocol (e.g., an HTTP GET method). At step 310, the publisher webserver sends the first webpage to the user device. In some embodiments, the response can be in accordance with the HTTP protocol. At step 315, the user device processes the received first webpage. For example, the web browser can process the first webpage source code in order to render the first webpage on a display of the user device and to execute instructions (e.g., javascript and/or HTML tags) included in and/or referenced by the first webpage source code. At step 320, the user device sends a request to an ad decision system (e.g., ad decisions system 105) for indicia of one or more impression opportunities. In some embodiments, the first webpage can include instructions (e.g., javascript and/or HTML tags) that, when executed by the user device, can cause the user device to send a request for the indicia of one or more impression opportunities to an ad decision system. For example, the first webpage can include a script (e.g., javascript) that causes the user device to request from the ad decision system the indicia of one or more impression opportunities.

At step 325, the ad decision system requests bids from one or more Demand Side Platforms (DSPs) (e.g., DSPs 120). In some embodiments, bids can be requested from other third-parties (e.g., Supply Side Platforms or any other advertisers). The ad decision system can request bids for one or more of the one or more impression opportunities. In some embodiments, the ad decision system can provide to the DSPs one or more key-values related to the one or more impression opportunities. For example, the ad decision system can receive key-values along with the request from the user device (e.g., key-values from the first webpage) and/or the ad decisions system can cull key-values from an HTTP header associated with the request for the indicia of one or more impression opportunities. At step 330, one or more of the one or more DSPs can provide bids for the one or more impression opportunities. For example, a DSP can bid on a banner ad space, while another DSP can bid on the banner ad space and another ad space.

At step 335, the ad decision system determines auction winners for each of the one or more impression opportunities. In some embodiments, the ad decisions system determines a lamest bid of the one or more bids for an impression opportunity. If the largest bid is greater than or equal to the cost associated with the impression opportunity, the ad decision system can record the winning bidder and select the impression opportunity for inclusion in the indicia of one or more impression opportunities. In some embodiments, the ad decision system can determine a value of an impression opportunity and a largest bid of the one or more bids. If the value or the largest bid is greater than or equal to a cost associated with the impression opportunity, the ad decision system can record the winning bidder and select the impression opportunity for inclusion in the indicia of one or more impression opportunities. In some embodiments, the ad decision system can participate in the auction by competing with other bidding DSPs. In some embodiments, the ad decision server can determine itself as the winner of the auction whenever it determines that the value of the impression opportunity exceeds the cost associated with the impression opportunity. At the conclusion of the auction, the ad decision system can identify each impression opportunity for which either the ad decision system or a third party is willing to pay a price equal to or greater than the cost associated with the impression opportunity and/or store ad information (e.g., information related to the winning bidder and/or which ad (e.g., the HTML code of the ad) the winning bidder wishes to display in the impression opportunity).

At step 340, the ad decision system responds with indicia of one or more impression opportunities and indicia of one or more ad buyers (e.g., indicia of which DSPs had the winning bids for the impression opportunities, or if the ad decision system won the auction). In some embodiments, the ad decision system can respond to the user device with a character string including the indicia of one or more impression opportunities and/or indicia of one or more ad buyers. In some embodiments, the ad decision system can respond with instructions (e.g., javascript and/or HTML tags) that, when executed by the user device, can cause the user device to set the value of a variable (e.g., as javascript variable) as the indicia of one or more impression opportunities and/or indicia of one or more ad buyers.

As described above, the indicia of one or more impression opportunities can identify impression opportunities (e.g., a top banner on the webpage, etc.). The indicia can include one or more keywords associated with impression opportunities. For example, the keyword “imp728” can correspond to a 728×90 pixel impression opportunity across the top of the webpage (e.g., the banner); the keyword “imp300” can correspond to a 300×250 pixel impression opportunity along the side of the webpage; and the keyword “imp160” can correspond to a 160×600 pixel impression opportunity. An exemplary response by the ad decision system can include “imp728;imp300;” as indicia of the 728×90 pixel impression opportunity and the 300×250 pixel impression opportunity.

At step 345, the user device stores the indicia of one or more impression opportunities received from the ad decision system. In some embodiments, the indicia can be stored as a cookie set on the domain of the first webpage. For example, the first webpage can include instructions javascript) to store as a cookie the value of a variable containing the indicia of one or more impression opportunities. In some embodiments, the user device stores indicia of one or more ad buyers (e.g., the information about which advertisers had the winning bids for the impression opportunities). The indicia of one or more ad buyers can he stored in a cookie. In some embodiments, the indicia of one or more impression opportunities is stored in a cookie set on the publisher's domain and the indicia of one or more ad buyers is stored in a cookie set on the ad decision system's domain. In some embodiments, the indicia of one or more impression opportunities and the indicia of one or more ad buyers are stored in cookies set on the same domain. In some embodiments, the indicia of one or more impression opportunities and the indicia of one or more ad buyers are stored for a duration of time and deleted thereafter (e.g., the ad decision system can specify the duration of time when providing the indicia of one or more impression opportunities and the indicia of one or more ad buyers).

At step 350, the user device sends a request for a second webpage to the publisher webserver. For example, the user device can request an updated version of the first webpage requested in step 305 or the user device can request another webpage hosted by the publisher. In sonic embodiments, the request can be in accordance with the HTTP protocol (e.g., an HTTP GET method). At step 355, the publisher webserver sends the second webpage to the user device, in some embodiments, the response can be in accordance with the HTTP protocol. At step 360, the user device processes the second webpage. For example, the user device can process the second webpage source code in order to render the second webpage on a display of the user device and to execute instructions (e.g., javascript and/or HTML tags) included in and/or referenced by the second webpage source code.

At step 365, the user device retrieves stored indicia of one or more impression opportunities. As described above, the user device can store the indicia of one or more impression opportunities received from the ad decision system during the processing of a previous webpage (e.g., the first webpage displayed in step 345). In some embodiments, the second webpage can include instructions (e.g., javascript and/or HTML tags) that, when executed by the user device, can cause the user device to retrieve the stored indicia of one or more impression opportunities. For example, the user device can retrieve the indicia of one or more impression opportunities stored in a cookie set on the domain of the first webpage requested in step 305 (e.g., when the second webpage is on the same domain as the first webpage). The requested second webpage can include instructions (e.g., javascript) to retrieve from a cookie the indicia of one or more impression opportunities and set the value of a variable to the indicia of one or more impression opportunities.

At step 370, the user device sends a request to the publisher ad server for an ad for displaying in an impression opportunity in the second webpage. In some embodiments, the request includes the indicia of one or more impression opportunities. For example, the indicia can be appended as parameters to the URL specified for the publisher ad server. In the illustrated embodiment, the user device can provide the indicia of one or more impression opportunities retrieved in step 165.

At step 375, the publisher ad server responds with an ad tag. In some embodiments, the publisher ad server determines which ad tag to send based in part on the indicia of one or more impression opportunities included in the request that it received from the user device. In some embodiments, the publisher ad server can send an ad tag that, when processed by the user device, directs the user device to the location from which to retrieve the selected ad.

At step 380, the user device sends a request to the ad decision system for an ad or ad tag (e.g., as a result of processing the ad tag provided by the publisher ad server). In some embodiments, the user device provides the indicia of one or more ad buyers to the ad decisions system. At step 383, the ad decision system responds with an ad tag. For example, if the indicia of one or more ad buyers indicate that a third party DSP was the winning bidder for the impression opportunity, the ad decision system can send an ad tag directing the user device to the server of the winning bidder DSP. In some embodiments, the ad decision system can send an ad tag based on the ad information. For example, the ad decision system can send an ad tag for an ad indicated by the ad information. At step 385, the user device sends a request to the winning bidder DSP for an ad. At step 390, the winning bidder DSP sends an ad to the user device. At step 395, the user device displays the ad in the second webpage.

Ad Decision System Method

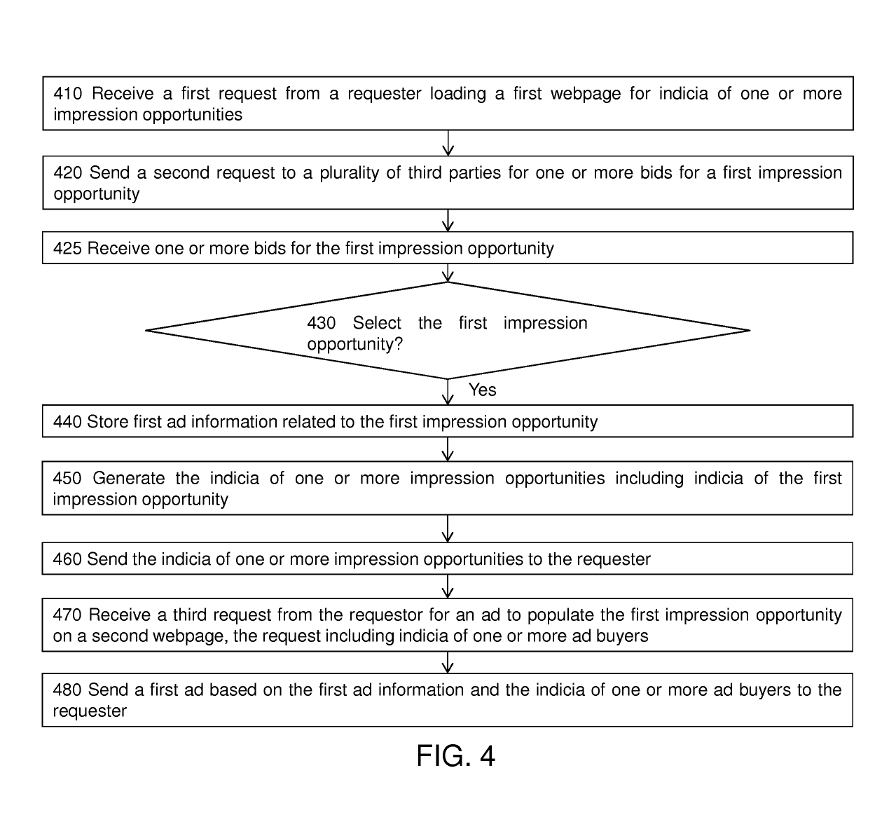

FIG. 4 depicts a flow chart illustrating a method performed by an ad decision system in accordance with an embodiment of the technology. In some embodiments, the illustrated method can be performed by an ad decision system (e.g., ad decision system 105). At step 410, the ad decision system can receive a first request from a requester loading a first webpage for indicia of one or more impression opportunities (e.g., as described, with respect to step 320 of FIG. 3A). At step 420, the ad decision system can send a second request to a plurality of third parties for one or more bids for a first impression opportunity (e.g., as described with respect to step 325 of FIG. 3A). At step 425, the ad decision system can receive one or more bids for the first impression opportunity. At step 430, the ad decision system can determine whether to select the first impression opportunity (e.g., as described with respect to steps 325 through 335 of FIG. 3A). If the first impression is selected, the ad decision server can store first ad information related to the first impression opportunity at step 440 (e.g., as described with respect to steps 325 through 335 of FIG. 3A). At step 450, the ad decision system can generate the indicia of one or more impression opportunities including indicia of the first impression opportunity (e.g., as described with respect to steps 325 through 340 of FIG. $A). At step 460, the ad decisions system can send the indicia of one or more impression opportunities to the requester (e.g., as described with respect to step 340 of FIG. 3A). At step 470, the ad decision system can receive a third request from the requestor for an ad to populate the first impression opportunity on a second webpage, the request including indicia of one or more ad buyers (e.g., as described with respect to step 380 of FIG. 3B). At step 480, the ad decision system can send a first ad (or ad tag) based on the first ad information and the indicia of one or more ad buyers to the requester (e.g., as described with respect to step 383 of FIG. 313).

### User Device Method

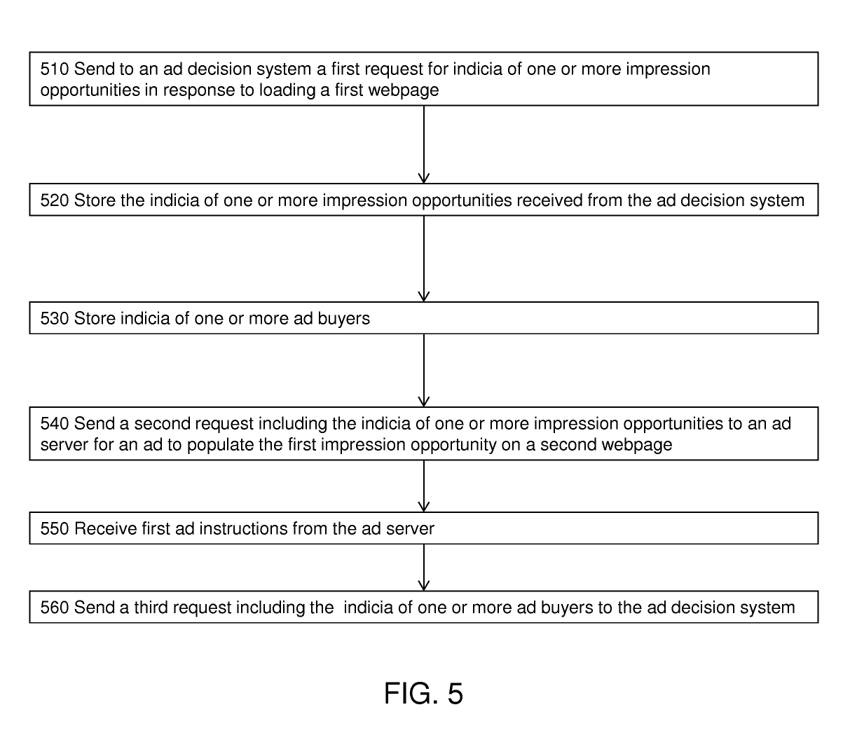

FIG. 5 depicts a flow chart illustrating a method performed by a user device in accordance with an embodiment of the technology. In some embodiments, the illustrated method can be performed by a user device (e.g., user device 125). At step 510, the user device can send to an ad decision system a first request for indicia of one or more impression opportunities in response to loading a first webpage (e.g., as described with respect to step 320 of FIG. 3A). At step 520, the user device can store the indicia of one or more impression opportunities received from the ad decision system (e.g., as described with respect to step 345 of FIG. 3A). At step 530, the user device can store indicia of one or more ad buyers, wherein each ad buyer of the one or more ad buyers is associated with at least one impression opportunity of the one or more impression opportunities (e.g., as described, with respect to step 345 of FIG. 3A). At step 540, the user device can send a second request including the indicia of one or more impression opportunities to an ad server for an ad to populate the first impression opportunity on a second webpage (e.g., as described with respect to step 370 of FIG. 3B). At step 550, the user device can receive first ad instructions from the publisher ad server (e.g., as described with respect to step 375 of FIG. 313). At step 560, the user device can send a third request including the indicia of one or more ad buyers to the ad decision system (e.g., as described with respect to step 380 of FIG. 3B).

Some embodiments of the technology are described above with reference to webpages. It should be appreciated that the technology can be applied to selecting and/or providing advertisements for any digital asset that includes one or more impression opportunities. Digital assets can include webpages, multi-media items, applications, etc. As an example, the technology can be applied to selecting and/or providing advertisements for display in impression opportunities in an application (e.g., an application on a personal computer, an application on a mobile computing device, etc.),

The above-described techniques can he implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can he written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also he performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices. e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Bin-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well for example, feedback provided to the user can be any form of sensory feedback, visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be to client computer having a graphical user interface, a web browser through which a user can interact with an example implementation, and/or other graphical user interfaces for a transmitting device. The above described techniques can be implemented in a distributed computing system that includes any combination of such back-end, middleware, or front-end components.

The components of a computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example. Ethernet protocol, Internet Protocol (IP), a Peer-to-Peer (P2P) protocol, Hypertext Transfer Protocol (HTTP), Session Initiation Protocol (SIP), a Global System for Mobile Communications (GSM) protocol, Universal Mobile Telecommunications System (UMTS), 3GPP Long Term Evolution (LTE) and/or other communication protocols.

Devices of a computing system can include, for example, a computer, a computer with as browser device, a telephone, an IP phone, a mobile device (e,g., cellular phone, personal digital assistant (PDA) device, smart phone, tablet, laptop computer, electronic mail device), and/or other Communication devices. The browser device includes, for example, a computer (e.g., desktop computer and/or laptop computer) with a World Wide We browser (e.g., Chrome™ from Google, Inc., Microsoft® Internet Explorer® available from Microsoft Corporation, and/or Mozilla® Firefox available from Mozilla Corporation). Mobile computing device includes, for example, a Blackberry® from Research in Motion, an iPhone® from Apple Corporation, and/or an Android™-based device. IP phones include, for example, a Cisco® Unified IP Phone 79856 and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method performed by a computing system comprising:
receiving, by the computing system, a first request from a requester loading a first webpage for indicia of one or more impression opportunities;
sending, by the computing system, a second request to a plurality of third parties for one or more bids for a first impression opportunity;
determining, by the computing system, whether to select the first impression opportunity based on the one or more bids received from one or more of the plurality of third parties;
if the first impression opportunity is selected:
storing, by the computing system, first ad information related to the first impression opportunity;
generating, by the computing system, the indicia of one or more impression opportunities comprising indicia of the first impression opportunity;
sending, by the computing system, the indicia of one or more impression opportunities to the requester;
receiving, by the computing system, a third request from the requestor for an ad to populate the first impression opportunity on a second webpage, the request comprising indicia of one or more ad buyers; and
sending, by the computing system, a first ad based on the first ad information and the indicia of one or more ad buyers to the requester.

2. The method of claim 1, further comprising:
receiving, by the computing system, one or more key-values from the requester; and
wherein the second request comprises the one or more key-values.

3. The method of claim 1, further comprising:
determining, by the computing system, a largest bid of the one or more bids; and
selecting, by the computing system, the first impression opportunity if the largest bid is greater than or equal to a cost associated with the first impression opportunity,

4. The method of claim 1, further comprising:
determining, by the computing system, a value of the first impression opportunity;
determining, by the computing system, a largest bid of the one or more bids; and
selecting, by the computing system, the first impression opportunity if the value or the largest bid is greater than or equal to a cost associated with the first impression opportunity.

5. The method of claim 1, further comprising, sending, by the computing system, storage instructions to the requester to store the indicia of the one or more impression opportunities.

6. The method of claim 5, wherein the storage instructions comprise instructions to store the indicia of the one or more impression opportunities for a duration of time.

7. The method of claim 5, wherein the storage instructions comprise instructions to store the indicia of the one or more impression opportunities as a web browser cookie.

8. The method of claim I, wherein the indicia of the one or more impression opportunities comprise one or more keywords associated with an ad server.

9. A method performed by a computing system comprising:
sending, by the computing system, to an ad decision system a first request for indicia of one or more impression opportunities in response to loading a first webpage;
storing, by the computing system, the indicia of one or more impression opportunities received from the ad decision system;
storing, by the computing system, indicia of one or more ad buyers, wherein each ad buyer of the one or more ad buyers is associated with at least one impression opportunity of the one or more impression opportunities;
sending, by the computing system, a second request comprising the indicia of one or more impression opportunities to an ad server for an ad to populate the first impression opportunity on a second webpage;
receiving, by the computing system, first ad instructions from the ad server; and
sending, by the computing system, a third request comprising the indicia of one or more ad buyers to the ad decision system,

10. The method of claim 9, further comprising sending, by the computing system, to the ad decision system one or more key-values associated with the one or more impression opportunities.

11. The method of claim 9, further comprising, receiving, by the computing system, storage instructions from the ad decision system to store the indicia of the one or more impression opportunities on the computing system.

12. The method of claim 11, wherein the storage instructions comprise instructions to store the indicia of the one or more impression opportunities for a duration of time on the computing system.

13. The method of claim 11, wherein the storage instructions comprise instructions to store the indicia of the one or more impression opportunities as a web browser cookie on the computing system.

14. The method of claim 9, wherein the indicia of the one or more impression opportunities comprise one or more keywords associated with the ad server.
